(19) United States
(12) Patent Application Publication
(10) Pub. No.: US 2024/0291146 A1
(43) Pub. Date: Aug. 29, 2024

(54) TRANSMISSION APPARATUS AND PHASE SHIFTING ASSEMBLY

(71) Applicants: PROSE TECHNOLOGIES (SUZHOU) CO., LTD., Suzhou (CN); PROSE TECHNOLOGIES LLC, Mount Olive, NJ (US)

(72) Inventors: Peng LIU, Suzhou (CN); Yongzhong LI, Suzhou (CN)

(21) Appl. No.: 18/659,177

(22) Filed: May 9, 2024

Related U.S. Application Data
(63) Continuation of application No. PCT/CN2022/077101, filed on Feb. 21, 2022.

(30) Foreign Application Priority Data
Nov. 9, 2021 (CN) 202111318885.6

(51) Int. Cl. H01Q 3/32; F16H 19/04

(52) U.S. Cl. CPC H01Q 3/32; F16H 19/04

(57) ABSTRACT

A transmission apparatus includes a gear, a rack, and a fixture mechanism. The gear includes a first stopper and a pivot shaft. The first stopper is arranged at at least one end of a gear member extending along a longitudinal axis of the gear. The rack meshes with the gear in an assembly state and includes a second stopper corresponding to the first stopper. The fixture mechanism includes a gear fixing hole and a guidance groove. The gear rotates relative to the fixture mechanism via the pivot shaft. The pivot shaft passes through the gear fixing hole. The rack translates relative to the fixture mechanism through the guidance groove.

### CROSS-REFERENCES TO RELATED APPLICATIONS

This application is a continuation of International Application No. PCT/CN2022/077101, filed on Feb. 21, 2022, which claims priority to Chinese Patent Application No. 202111318885.6, filed on Nov. 9, 2021, the entire contents of which are incorporated herein by reference.

### TECHNICAL FIELD

The present disclosure generally relates to the communication technology field and, more particularly, to a transmission apparatus of a stop structure and a phase shifting assembly of the transmission apparatus.

### BACKGROUND

A transmission structure of the existing antenna is typically controlled by an electronic tilt adjustment component to control a phase shifter to perform a corresponding phase adjustment. Then, downward tilt of the antenna is realized.

When the transmission structure is initially assembled and subsequently operated, a position of the transmission structure relative to the phase shifter needs to be found to avoid position deviation between the transmission structure and the phase shifter.

The technical problem about the position deviation, for example, can be solved through positioning using a sensor or arranging a positioning mechanism at the transmission structure. The technical solution of using the sensor for positioning has a high requirement for the sensitivity of the electronic tilt adjustment component. The method of adding the positioning mechanism at the transmission structure is relatively simple, and the precision is relatively poor.

When applying the above two transmission structures in a conventional antenna, the precision of the phase control of the phase shifter is caused to be poor. When the transmission structures are applied in a multiple-input multiple-output (MIMO) antenna, it is difficult to ensure the consistency of the phase adjustment realized by the plurality of phase shifters and the stability of the phase adjustment. In addition, the existing transmission structure has disadvantages such as large structure space, heavyweight, and high cost.

### SUMMARY

Embodiments of the present disclosure provide a transmission apparatus including a gear, a rack, and a fixture mechanism. The gear includes a first stopper and a pivot shaft. The first stopper is arranged at at least one end of a gear member extending along a longitudinal axis of the gear. The rack meshes with the gear in an assembly state and includes a second stopper corresponding to the first stopper. The fixture mechanism includes a gear fixing hole and a guidance groove. The gear is configured to rotate relative to the fixture mechanism via the pivot shaft. The pivot shaft passes through the gear fixing hole. The rack is configured to translate relative to the fixture mechanism through the guidance groove.

In the transmission apparatus of the present disclosure, the gear can mesh with the rack with the help of the fixture mechanism. The gear and the rack can stop moving with the help of the cooperation of the first stopper and the second stopper arranged at the gear and the rack. Thus, the initial position and/or ending position of the travel can be precisely positioned. Such stoppers may not significantly increase the volume of the gear and the rack. That is, the transmission apparatus of the present disclosure has a simple structure and high precision.

Embodiments of the present disclosure provide a phase-shifting assembly, including a phase shifter and a transmission apparatus. The transmission apparatus includes a gear, a rack, and a fixture mechanism. The gear includes a first stopper and a pivot shaft. The first stopper is arranged at at least one end of a gear member extending along a longitudinal axis of the gear. The rack meshes with the gear in an assembly state and includes a second stopper corresponding to the first stopper. The fixture mechanism includes a gear fixing hole and a guidance groove. The rack is mechanically connected to a dielectric plate of the phase shifter. The gear rotates relative to the fixture mechanism via the pivot shaft. The pivot shaft passes through the gear fixing hole. The rack translates relative to the fixture mechanism through the guidance groove.

In the transmission apparatus of the present disclosure, the gear and the rack can mesh with each other with the assistance of the fixture mechanism. The gear and the rack can stop moving with the help of the cooperation of the first stopper and the second stopper arranged at the gear and the rack. Thus, the initial position and/or ending position of the travel can be precisely positioned. Such stoppers may not significantly increase the volume of the gear and the rack. That is, the transmission apparatus of the present disclosure has a simple structure and high precision. Thus, the phase shifter including the transmission apparatus of the present disclosure can also have the advantages of simplifying the structure while improving the precision.

### BRIEF DESCRIPTION OF THE DRAWINGS

FIG. 1 is a schematic perspective diagram of a transmission apparatus including a gear and a rack according to some embodiments of the present disclosure.

FIG. 2 is a schematic diagram of a gear included in the transmission apparatus in FIG. 1 according to some embodiments of the present disclosure.

FIG. 3 is a schematic diagram of the transmission apparatus in FIG. 1 when the gear meshes with the rack according to some embodiments of the present disclosure.

FIG. 4 is a schematic structural diagram of a transmission apparatus including a fixed mechanism according to some embodiments of the present disclosure.

FIG. 5 is a schematic exploded diagram of the transmission apparatus in FIG. 4.

FIG. 6 is a schematic diagram of another transmission apparatus according to some embodiments of the present disclosure.

FIG. 7 is a schematic perspective diagram of a transmission apparatus including a gear and a rack according to some embodiments of the present disclosure.

FIG. 8 is a schematic structural diagram of a transmission apparatus including a fixture mechanism according to some embodiments of the present disclosure.

FIG. 9 is a schematic exploded diagram of the transmission apparatus in FIG. 8.

### DETAILED DESCRIPTION OF THE EMBODIMENTS

Embodiments of the present disclosure are described in connection with the accompanying drawings of embodiments of the present disclosure. Although the exemplary methods and apparatuses described below include software and/or firmware executed on hardware of other assemblies, embodiments are exemplary and do not limit the present disclosure. For example, any or all hardware, software, and firmware assemblies can be implemented in hardware alone, software alone, or any combination thereof. Thus, although the methods and apparatus are described below, those skilled in the art should know that embodiments of the present disclosure are not used to limit the implementations of the methods and the apparatus.

In addition, the flowcharts and diagrams in the accompanying drawings illustrate system architectures, functions, and operations of methods and systems according to embodiments of the disclosed. The functions indicated in the diagram can also occur in an order different from the order indicated in the accompanying drawings. For example, two grounded blocks can be performed in parallel, or in a reverse order, which depends on the related function. Each block of the flowchart and/or block diagram and a combination of the blocks of the flowchart and/or the block diagram can be implemented by a system based on the hardware configured to perform determined functions or operations or a combination of special-purpose hardware and computer instructions.

Based on the above, the following technical problems exist in the existing technology. That is, the structure is complex or the control precision is poor no matter the technical solution of using the sensor to perform position detection or the technical solution of adding positioning to the transmission structure.

The purpose of the present disclosure is to provide a transmission apparatus. Stopping structures can be added to a gear and rack assembly, respectively. The stopping structures can occupy a small space and can be used to lower the transmission cost and reduce the weight. Thus, the precision and stability of the transmission can be improved.

Theoretically, in the technical solution of the present disclosure, a gear and rack assembly can be used. A motor can be configured to drive a pivot shaft to transmit the rotation of the gear to the rack and convert the rotation into linear sliding. A stop structure can be added to the rack. Stop structures can also be added to two sides of the gear. Rack travel can be longer than the travel of the phase shifter, and the phase shifter can be protected. In addition, to control the consistency of batch assembly, the gear-rack structure can be mounted at a stopping position of any one end. During movement, stopping calibration can be performed on any one end or both ends to control the transmission precision. Meanwhile, the gear and rack can also have a guidance function, which greatly improves the stability of the transmission.

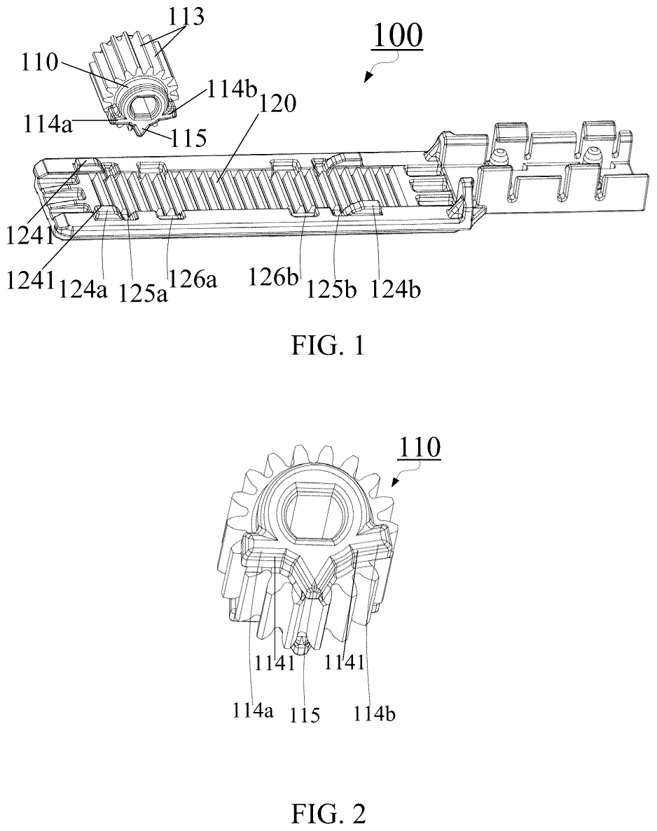

Structures of transmission apparatuses of embodiments of the present disclosure are described in connection with FIG. 1 to FIG. 10. However, those skilled in the art should understand embodiments of the present disclosure are merely exemplary not limiting. The technical solution can be within the scope of the present disclosure as long as the technical solution is within the scope of the claims.

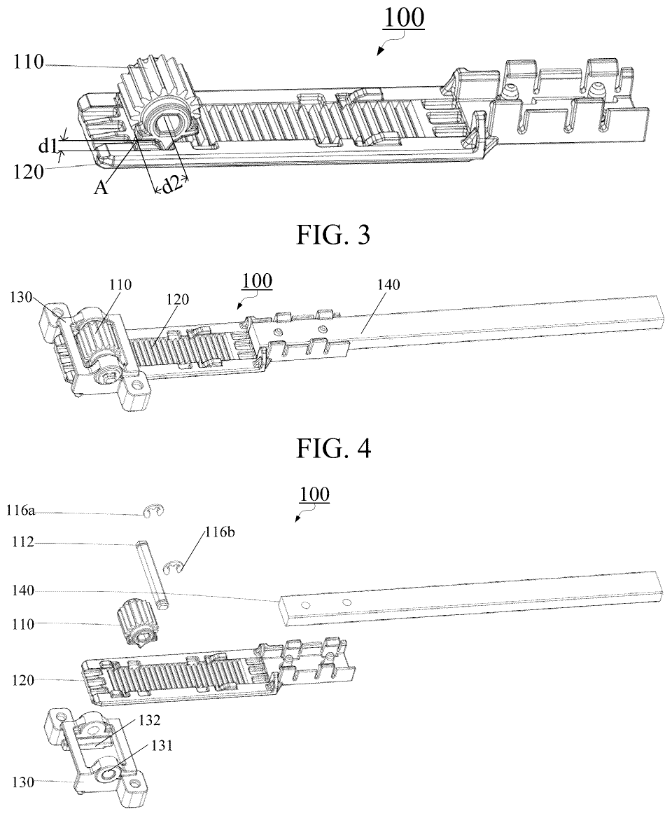

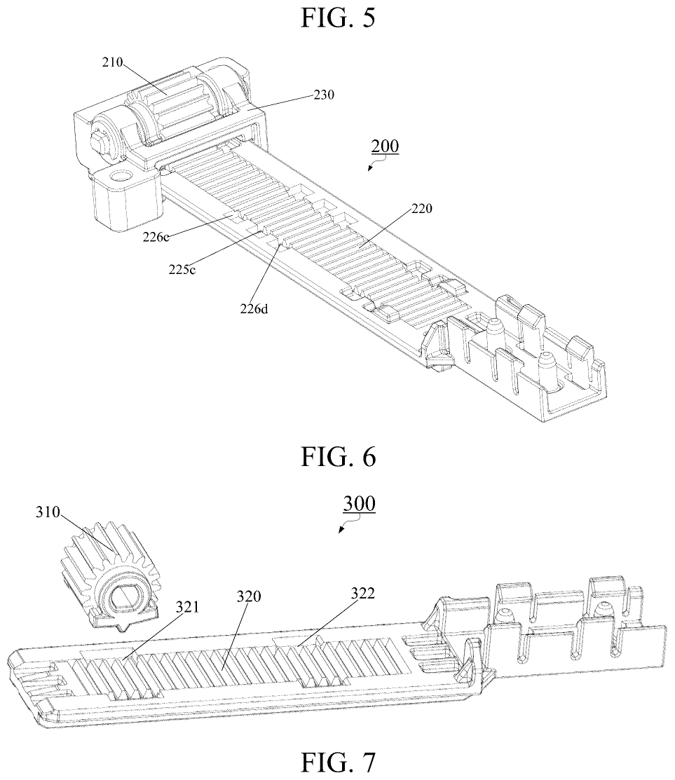

The present disclosure provides a transmission apparatus. FIG. 1 to FIG. 5 illustrate diagrams showing different views of a transmission apparatus 100 according to embodiments of the present disclosure. FIG. 1 is a schematic perspective diagram of the transmission apparatus 100 including a gear 110 and a rack 120 according to some embodiments of the present disclosure. FIG. 2 is a schematic diagram of the gear 110 included in the transmission apparatus 100 in FIG. 1 according to some embodiments of the present disclosure. FIG. 3 is a schematic diagram of the transmission apparatus 100 in FIG. 1 when the gear 110 meshes with the rack 120 according to some embodiments of the present disclosure. FIG. 4 is a schematic structural diagram of the transmission apparatus 100 including a fixture mechanism 130 according to some embodiments of the present disclosure. FIG. 5 is a schematic exploded diagram of the transmission apparatus 100 in FIG. 4.

To clearly describe the stop structure of the present disclosure, in connection with FIG. 1 and FIG. 2, the positions and shape features of the stop structures are described. As shown in FIG. 1 and FIG. 2, the transmission apparatus 100 of the present disclosure includes at least one gear 110 and one rack 120. The gear 110 includes a first stopper 114a and a pivot shaft 112 (e.g., shown in FIG. 5), the first stopper 114a being arranged at at least one end (e.g., an end close to the paper) of a gear member 113 extending along a longitudinal axis (e.g., a black solid line 111 in the middle of the gear in FIG. 3) of the gear 110. The rack 120 can mesh with the gear 110 in an assembly state and include a second stopper 124a corresponding to the first stopper 114a. In addition, FIG. 2 illustrates a diagram of the gear 110 included in the transmission apparatus 100 in FIG. 1. As shown in FIG. 2, two first stoppers are provided, i.e., the first stopper 114a and the first stopper 114b. Moreover, for example, a positioning member 115 can be arranged between the first stopper 114a and the first stopper 114b.

To illustrate a meshing state of the gear 110 and the rack 120, FIG. 3 shows a schematic diagram of the transmission apparatus 100 in FIG. 1 when the gear 110 meshes with the rack 120. As shown in FIG. 3, a distance between teeth of the gear 110 and a distance between teeth of the rack 120 are approximately same. Thus, the gear 110 and the rack 120 can mesh well with each other to realize a stable transmission. In some embodiments, the first stopper 114a/114b includes a first stress surface 1141, and the second stopper 124a/124b includes a second stress surface 1241. When the first stopper 114a/114b is in contact with the second stopper 124a/124b, the first stress surface 1141 can be parallel with the second stress surface 1241. That is, the first stopper 114a/114b can be in surface not point contact with the second stopper 124a/124b. Thus, the first stopper and the second stopper can be stressed uniformly to prevent the first stopper 114a/114b from being broken up due to concentrated stress. In some embodiments, the gear and the rack can be further configured as follows. When the first stopper is in contact with the second stopper, the first stressed surface can be configured to be parallel with the surface where the index line of the rack is located. Thus, when the first stopper is in contact with the second stopper, the second stopper can only be subject to the force perpendicular to the surface where the index line of the rack is located and cannot be subject to the force in a forward direction of the rack.

To perform a mechanical connection on the gear 110 relative to the rack 120, the transmission apparatus 100, for example, can further include a fixture mechanism 130. To show the fixture mechanism 130, the fixture mechanism 130 is described in connection with FIG. 4 and FIG. 5. FIG. 4 shows a diagram showing an assembly of the transmission apparatus 100 including the fixture mechanism 130. FIG. 5 shows an exploded diagram of the transmission apparatus 100 in FIG. 4. As shown in FIG. 4 and FIG. 5, the fixture mechanism 130 includes a gear fixing hole 131 and a guidance member 132. The gear 110 can rotate relative to the fixture mechanism 130 through the pivot shaft 112. The pivot shaft 112 passes through the gear fixing hole 131, and the rack 120 can perform translation movement relative to the fixture mechanism 130 through the guidance groove 132. Thus, in the transmission apparatus 100 of the present disclosure, the gear 110 can mesh with the rack 120 with the assistance of the fixture mechanism 130. Then, the gear 110 and the rack 120 can stop moving with the assistance of the first stopper 114a and the second stopper 124a to precisely position the initial position and/or the ending position. Such the first stopper 114a and the second stopper 124a may not obviously increase the volume of the gear 110 and the rack 120. That is, the transmission apparatus 100 of the present disclosure can have a simple structure and high precision. As shown in FIG. 5, to fix the pivot shaft 112 in the gear fixing hole 131 of the fixture structure 130, a hook 116a and a hool 116b are arranged at an outer side of the gear fixing hole 131 to limit the position of the pivot shaft 112.

In some embodiments of the present disclosure, in the assembly state (e.g., the states in FIG. 3 and FIG. 4), since the mesh of the gear 110 and the rack 120 is stable, a first distance from a longitudinal center axis of the pivot shaft 112 to the rack plane of the rack 120 can be fixed. To cause the second stopper 124a to stop the first stopper 114a from rotating continuously to the left side of FIG. 3 or FIG. 4, when the first stopper 114a is in contact with the second stopper 124a, a sum of distance d2 from the contacting part of the first stopper 114a (e.g., point A of the first stopper 114a in FIG. 3) to the longitudinal center axis of the pivot shaft 112 and distance d1 from point A of the contacting part of the second stopper 124a to the rack plane is greater than the first distance. Thus, the second stopper 124a can block the first stopper 114a. Then, those skilled in the art can understand that the second stopper 124a can be represented by exceeding the rack plane. However, the technical solution of the present disclosure is not limited to this. The technical solution of the present disclosure can also include a technical solution with the second stopper 124a being in the rack plane or even lower than the rack plane. The concept of the technical solution can include that a sum of the distance from point A of the contacting part to the longitudinal center axis of the gear 110 and the distance from point A of the contacting part to the rack plane (e.g., the distance being negative when point A of the contacting part is lower than the rack plane) has to be greater than the distance from the longitudinal center axis 111 of the gear 110 to the rack plane. Thus, when the first stopper 114a is in contact with the second stopper 124a, the gear 110 cannot continuously rotate in the direction toward the second stopper 124a to realize the stopping effect.

In some embodiments, the pivot shaft 112 may not be regularly cylindrical. For example, FIG. 5 shows an outer contour including a partial planar shape. Thus, the gear 110 may not rotate relative to the pivot shaft 112. In some embodiments, the pivot shaft 112 can be separated from the gear member of the gear 110. Those skilled in the art should understand that the pivot shaft 112 and the gear member of the gear 110 can also be integrally formed, as long as the drive motor can drive the gear 110 to rotate, thereby driving the rack 120 to move. In some embodiments, those skilled in the art should understand that the transmission method can include for example, driving the pivot shaft 112 to rotate by the drive motor to drive the gear 110 to rotate and the rack 120 to move, or driving another gear by the drive motor to drive the rack 120 to move through the meshing transmission between the another gear and the gear 110.

In embodiments of the present disclosure, the gear 110 can include a third stopper (not shown in the figure) at another end (e.g., the end of the gear 110 away from the paper surface) corresponding to an end where the first stopper 114a is located. Moreover, the rack 120 can include a fourth stopper corresponding to the third stopper. Thus, the two ends of the gear 110 can be effectively stopped to improve the stopping effect and stability during the transmission of the gear 110 and the rack 120. In some embodiments, the first stopper 114a and the third stopper can be symmetrical about a plane perpendicular to the longitudinal axis of the gear. In some embodiments, the second stopper 124a and the fourth stopper can also be symmetrical, for example, about a plane perpendicular to an axis of the forward direction of the rack. In some embodiments, as shown in FIG. 1 to FIG. 6, the second stopper 124a is configured as a protrusion on the rack plane of the rack 120. In some other embodiments, as shown in FIG. 7 to FIG. 9, the second stopper is configured as a planar part in the rack plane. In some embodiments, the first stoppers 114a and 114b can be configured as two protrusions that are mirror symmetrical about the pivot shaft 112. In some embodiments, the positioning member 115 can be arranged between the two protrusions, and positioning grooves 125a and 125b corresponding to the positioning member 115 can be arranged at the rack 120.

In some embodiments, as shown in FIG. 1, the rack 120 includes avoidance grooves 126a and 126b. As shown in FIG. 1, the rack 120 includes four stoppers. Two of the four stoppers may not have reference numerals. The two outer stoppers can include the stopper 124a and the stopper 124b. When the gear 110 rotates relative to the rack 120, the stopper 124a and the stopper 124b can cooperate with the stopper 114a and the stopper 114b of the gear 110 to realize the left-right position limiting and stopping of the gear 110.

During operation, for example, the positioning member 115 of the gear 110 can be in the positioning groove 125a at the starting position. The stopper 114a can be in contact with the stopper 124a. Thus, the gear 110 cannot continuously rotate toward the left, i.e., cannot rotate counterclockwise to realize the stopping at the starting position. In addition, the initial position can be precisely positioned through the cooperation of the positioning grove 125a and the positioning member 115. Then, the gear 110, for example, can be driven by the drive piece. Due to the avoidance groove 126b of the stopper 114b, the stopper 114b may not stop the gear 110 continuing with the clockwise rotation. Then, with the avoidance groove 126b, the rack 120 can avoid the stopper 114a of the gear 110. Thus, the gear 110 can continue with the clockwise rotation. In the subsequent rotation, the positioning member 115 can cooperate with the positioning groove 125b to position the end position. Then, the stopper 114b can be in contact with the stopper 124b to stop the end position. Thus, the gear 110 cannot continue with the clockwise rotation.

In some embodiments, in the longitudinal axis of the gear 110, the length of the gear member 113 of the gear 110 can be the same as the length of the rack member of the rack 120. That is, the length of each tooth of the gear 110 along the longitudinal axis can be consistent with the length of each tooth of the rack along the longitudinal axis to realize more stable meshing. In some embodiments, the transmission apparatus 100 can further include a drive apparatus (not shown in the figure). The drive apparatus can be configured to drive the gear 110 to rotate through the pivot shaft 112 and drive the rack to move in a straight line through the gear 110.

As shown in FIG. 1 to FIG. 5, the gear 110 only rotates a turn relative to the rack 120. To cause the rack 120 to have a longer travel, for example, the gear 110 may need to rotate two turns or three truns. Thus, the rack 120 and the corresponding phase shifter can move a longer distance. Then, more avoidance grooves and positioning grooves can be arranged at the rack 120. Thus, the stopper of the gear 110 and the positioning member may not form the stopping structure with the rack 120 during the middle process. Those skilled in the art should understand that the stoppers only need to be arranged at the corresponding starting position and the ending position of the travel of the rack 120. FIG. 6 illustrates a schematic diagram of a transmission apparatus 200 according to embodiments of the present disclosure. As shown in FIG. 6, the transmission apparatus 200 of the present disclosure includes at least one gear 210 and one rack 220. The gear 210 includes a pivot shaft and a first stopper arranged at at least one end (e.g., an end close to the paper surface) of the gear member extending along the longitudinal axis of the gear 210. The rack 220 can mesh with the gear 210 in the assembly state and with the function of the fixture mechanism 230 and include a second stopper corresponding to the first stopper. The difference from embodiments of FIG. 1 to FIG. 5 can include that two additional avoidance grooves 226c and 226d are arranged at the middle of the rack 220. A positioning groove 225c can be arranged between the two avoidance grooves 226c and 226d. Thus, the gear 210 can rotate for example 2 turns in embodiments of FIG. 6.

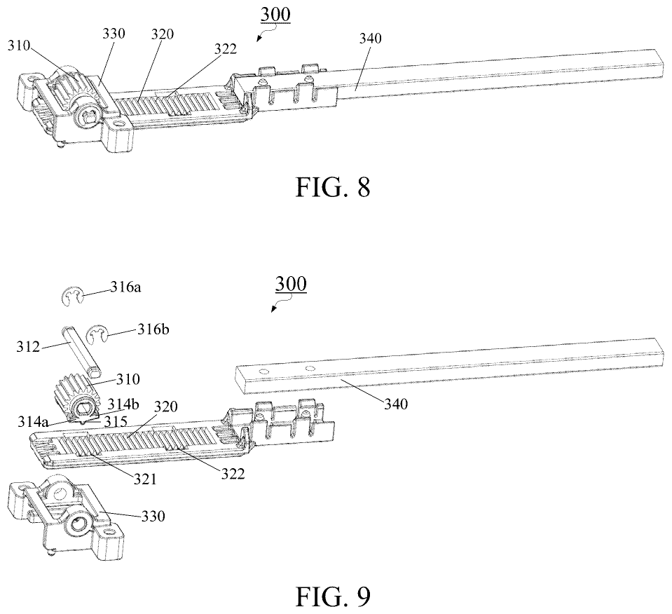

In addition, in embodiments of FIG. 1 to FIG. 6, the stoppers are protruded from the rack plane of the rack 120 or 220. However, those skilled in the art should understand that when the dimensions of the stoppers of the gear 110 or 210 are larger, the stoppers of the rack 120 or 220 may not protrude from the rack plane of the rack. FIG. 7 illustrates a schematic perspective diagram of a transmission apparatus 300 including a gear 310 and a rack 320 according to embodiments of the present disclosure. FIG. 8 is a schematic structural diagram of the transmission apparatus 300 including a fixture mechanism 330 according to some embodiments of the present disclosure. FIG. 9 is a schematic exploded diagram of the transmission apparatus 300 in FIG. 8. As shown in FIG. 7 to FIG. 9, the transmission apparatus 300 includes at least one gear 310 and one rack 320. The gear 310 includes first stoppers 314a and 314b and a pivot shaft 312. The first stoppers 314a and 314b are arranged at at least one end (e.g., the end close to the paper surface) of the gear member extending along the longitudinal axis of the gear 310. In the assembly state, the rack 320 can mesh with the gear 310 with the function of the fixture mechanism 330 and include the second stopper corresponding to the first stoppers 314a and 314b.

In embodiments shown in FIG. 7 to FIG. 9, the first stoppers 314a and 314b can be closer to the bottom compared to the stoppers 114a and 114b, i.e., further away from the pivot shaft of the gear 310. Thus, the first stoppers 314a and 314b can cooperate with an edge member of the rack 320 except the rack member to realize the stopping purpose. The positioning member 315 can be similar to the positioning member 115. The stopper of the gear 320 (e.g., a left part of the groove 321 and a right part of the groove 322) can be at the rack plane and even slightly lower than the rack plane. The difference between embodiments shown in FIG. 7 to FIG. 9 and the above embodiments can include that the positioning groove and the avoidance groove can be combined into a wider groove without being arranged separately in embodiments shown in FIG. 7 to FIG. 9. Those skilled in the art should understand that the positioning groove and the avoidance groove can also be arranged separately. Without being separately arranged, the steps for forming the rack 320 can be simplified to lower the manufacturing cost of the rack 320. Similar to FIG. 5, as shown in FIG. 9, to fix the pivot shaft 312 in the gear fixing hole of the fixture mechanism 330, hooks 316a and 316b are arranged at the outer side of the gear fixing hole to limit the position of the pivot shaft 312.

In addition, a second aspect of the present disclosure provides a phase-shifting assembly. The phase shifting assembly can include a phase shifter and the transmission apparatuses 100, 200, and 300 of a first aspect of the present disclosure. The rack 110, 210, or 310 of the transmission apparatus 100, 200, or 300 can be mechanically connected to a dielectric plate in the phase shifting assembly. As shown in FIG. 4 and FIG. 5, the transmission apparatus 100, for example, is mechanically connected to the dielectric plate in the phase shifting assembly through the rod member 140. Correspondingly, as shown in FIG. 4 and FIG. 5, the transmission apparatus 300 can be mechanically connected to the dielectric plate of the phase shifting assembly through the rod member 340. In the transmission apparatus including the gear-rack assembly of the present disclosure, the axial rotation of the motor can be converted into the straight line movement of the rack through the gear and rack. Thus, a high-strength rod can be driven by the rack to be connected to the phase shifter to realize the phase adjustment of the phase shifter. Meanwhile, the gear and the rack can also have a guidance function, which greatly improves the stability of the transmission and the transmission precision. The layout of the whole space can be more impact.

In summary, in the transmission apparatus of the present disclosure, the gear can mesh with the rack through the fixture mechanism. Thus, the gear and the rack can stop through the first stopper and the second stopper at the gear and the rack. Thus, the initial position and/or the ending position can be positioned precisely. Thus, such the stoppers may not increase the volumes of the gear and the rack. That is, the transmission apparatus of the present disclosure can have a simple structure and high precision. Thus, with the phase shifter including the transmission apparatus of the present disclosure, the structure can also be simplified, and the precision can be improved.

The above are some embodiments of the present disclosure and are not used to limit embodiments of the present disclosure. For those skilled in the art, various modifications and changes can be made to embodiments of the present disclosure. Any modifications, equivalent replacements, and improvements made within the spirit and principle of embodiments of the present disclosure should be within the scope of the present disclosure.

Although embodiments of the present disclosure are described, embodiments of the present disclosure are not limited to the described embodiments. The content of the present specification is intended to cover various modifications and equivalent arrangements within the scope and spirit of the appended claims. The scope of the claims is broadly interpreted to cover all such modifications and equivalent structures and functions.

What is claimed is:

1. A transmission apparatus comprising:
a gear, including a first stopper and a pivot shaft, the first stopper being arranged at at least one end of a gear member extending along a longitudinal axis of the gear;
a rack, meshing with the gear in an assembly state and including a second stopper corresponding to the first stopper; and
a fixture mechanism, including a gear fixing hole and a guidance groove,
wherein:
the gear is configured to rotate relative to the fixture mechanism via the pivot shaft;
the pivot shaft passes through the gear fixing hole; and
the rack is configured to translate relative to the fixture mechanism through the guidance groove.

2. The apparatus according to claim 1, wherein:
in the assembly state, a first distance from a longitudinal center axis of the pivot shaft to a rack plane of the rack is fixed;
in response to the first stopper contacting the second stopper, a sum of a distance from a contacting part of the first stopper to the longitudinal center axis of the pivot shaft and a distance from a contacting part of the second stopper to the rack plane is greater than the first distance.

3. The apparatus according to claim 1, wherein the pivot shaft and the gear member of the gear are separated.

4. The apparatus according to claim 1, wherein:
the gear includes a third stopper at another end opposite to an end where the first stopper is located; and
the rack includes a fourth stopper corresponding to the third stopper.

5. The apparatus according to claim 4, wherein the first stopper and the third stopper are symmetrical about a plane perpendicular to the longitudinal axis of the gear.

6. The apparatus according to claim 4, wherein the second stopper and the fourth stopper are symmetrical.

7. The apparatus according to claim 1, wherein the second stopper is configured as a protrusion above the rack plane.

8. The apparatus according to claim 1, wherein the second stopper is configured as a planar part in the rack plane.

9. The apparatus according to claim 1, wherein the first stopper is configured as two protrusions mirror-symmetrical about the pivot shaft.

10. The apparatus according to claim 9, wherein:
the gear includes a positioning member between the two protrusions; and
the rack includes a positioning groove corresponding to the positioning member.

11. The apparatus according to claim 1, wherein the rack includes an avoidance groove.

12. The apparatus according to claim 1, wherein, in a longitudinal axis of the gear, a length of the gear member of the gear is equal to a length of the rack member of the rack.

13. The apparatus according to claim 1, further comprising: a drive apparatus configured to drive the gear to rotate and to drive, through the gear, the rack to move in a straight line.

14. The apparatus according to claim 1, wherein:
the first stopper includes a first stress surface, and the second stopper includes a second stress surface; and
in response to the first stopper contacting the second stopper, the first stress surface is parallel to the second stress surface.

15. The apparatus according to claim 14, wherein the first stress surface and the longitudinal axis of the gear are coplanar.

16. The apparatus according to claim 14, wherein, in response to the first stopper contacting the second stopper, the first stress surface is configured to be parallel to a plane where an index line of the rack is.

17. A phase-shifting assembly comprising:
a phase shifter; and
a transmission apparatus,
wherein the rack is mechanically connected to a dielectric plate of the phase shifter, and the transmission apparatus comprises:
a gear, including a first stopper and a pivot shaft, the first stopper being arranged at at least one end of a gear member extending along a longitudinal axis of the gear;
a rack, meshing with the gear in an assembly state and including a second stopper corresponding to the first stopper; and
a fixture mechanism, including a gear fixing hole and a guidance groove,
wherein:
the gear is configured to rotate relative to the fixture mechanism via the pivot shaft;
the pivot shaft passes through the gear fixing hole; and
the rack is configured to translate relative to the fixture mechanism through the guidance groove.

18. The phase shifting assembly according to claim 17, wherein:
in the assembly state, a first distance from a longitudinal center axis of the pivot shaft to the rack plane of the rack is fixed;
in response to the first stopper contacting the second stopper, a sum of a distance from a contacting part of the first stopper to the longitudinal center axis of the pivot shaft and a distance from a contacting part of the second stopper to the rack plane is greater than the first distance.

19. The phase shifting assembly according to claim 17, wherein the pivot shaft and the gear member of the gear are separated.

20. The phase shifting assembly according to claim 17, wherein:
the gear includes a third stopper at another end opposite to an end where the first stopper is located; and
the rack includes a fourth stopper corresponding to the third stopper.
